(19) United States
(12) Patent Application Publication
(10) Pub. No.: US 2010/0161565 A1
(43) Pub. Date: Jun. 24, 2010

(54) CLUSTER DATA MANAGEMENT SYSTEM AND METHOD FOR DATA RESTORATION USING SHARED REDO LOG IN CLUSTER DATA MANAGEMENT SYSTEM

(75) Inventors: Hun Soon LEE, Daejeon (KR); Byoung Seob Kim, Daejeon (KR); Mi Young Lee, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/543,208

(22) Filed: Aug. 18, 2009

(30) Foreign Application Priority Data
Dec. 18, 2008 (KR) 10-2008-0129638

(51) Int. Cl. G06F 17/30

(52) U.S. Cl. 707/674; 707/E17.007; 707/E17.032; 707/E17.01

(57) ABSTRACT

Provided are a cluster data management system and a method for data restoration using a shared redo log in the cluster data management system. The data restoration method includes collecting service information of a partition served by a failed partition server, dividing redo log files written by the partition server by columns of a table including the partition, restoring data of the partition on the basis of the collected service information and log records of the divided redo log files, and selecting a new partition server that will serve the data-restored partition, and allocating the partition to the selected partition server.

### CROSS-REFERENCE TO RELATED APPLICATIONS

This application claims priority under 35 U.S.C. §119 to Korean Patent Application No. 10-2008-0129638, filed on Dec. 18, 2008, in the Korean Intellectual Property Office, the disclosure of which is incorporated herein by reference in its entirety.

### TECHNICAL FIELD

The following disclosure relates to a data restoration method in a cluster data management system, and in particular, to a data restoration method in a cluster data management system, which uses a shared redo log to rapidly restore data, which are served by a computing node, when a failure occurs in the computing node.

### BACKGROUND

As the market for user-centered Internet services such as a User Created Contents (UCC) service and personalized services is rapidly increasing, the amount of data managed to provide Internet services is also rapidly increasing. Efficient management of large amounts of data is necessary to provide user-centered Internet services. However, because large amounts of data need to be managed, existing traditional Database Management Systems (DBMSs) are inadequate for efficiently managing such volumes in terms of performance and cost.

Thus, Internet service providers are conducting extensive research to provide higher performance and higher availability with a plurality of commodity PC servers and software specialized for Internet services.

Cluster data management systems such as Bigtable and HBase is an example of data management software specialized for Internet services. Bigtable is a system developed by Google that is being applied to various Google Internet services. HBase is a system being actively developed in an open source project by Apache Software Foundation along the lines of the Google's Bigtable concept.

FIG. 1 is a block diagram of a cluster data management system according to the related art. FIG. 2 is a diagram illustrating a data model of a multidimensional map structure used in the cluster data management system of FIG. 1. FIGS. 3 and 4 are diagrams illustrating data management based on an update buffer in the cluster data management system of FIG. 1. FIG. 5 is a diagram illustrating reflection of the update buffer on a disk according to the related art.

Referring to FIG. 1, a cluster data management system 10 includes a master server 11 and partition servers 12-1, 12-2, . . . , 12-n.

The master server 11 controls an overall operation of the corresponding system.

Each of the partition servers 12-1, 12-2, . . . , 12-n manages a data service.

The cluster data management system 10 operates on a distributed file system 20. The cluster data management system 10 uses the distributed file system 20 to permanently store logs and data.

Hereinafter, a data model of a multidimensional map structure used in the cluster data management system of FIG. 1 will be described in detail with reference to FIG.2

Referring to FIG. 2, a multidimensional map structure includes rows and columns.

Table data of the multidimensional map structure are managed on the basis of row keys. Data of a specific column may be accessed through the name of the column. Each column has a unique name in the table. All data stored/managed in each column have the format of a byte stream without type. Also, not only single data but also a data set with several values may be stored/managed in each column. If data stored/managed in the column is a data set, one of the data is called a cell. Herein, the cell has a {key, values} pairs and the key of cell supports only a string type.

While the most of existing data management systems stores data in a row-oriented manner, the cluster data management system 10 stores data in a column(or column group)-oriented manner. The term ‘column group’ means a group of columns that have a high probability of being accessed simultaneously. Throughout the specification, the term ‘column’ is used as a common name for a column and a column group. Data are vertically divided per column. Also, the data are horizontally divided to a certain size. Hereinafter, a certain-sized division of data will be referred to as a ‘partition’. Service responsibilities for specific partitions are given to a specific node to enable services for several partitions simultaneously. Each partition includes one or more rows. One partition is served by one node, and each node manages a service for a plurality of partitions.

When an insertion/deletion request causes a change in data, the cluster data management system 10 performs an operation in such a way as to add data with new values, instead of changing the previous data. An additional update buffer is provided for each column to manage the data change on a memory. The update buffer is recorded on a disk, if it becomes greater than a certain size, or if it is not reflected on a disk even after the lapse of a certain time.

FIGS. 3 and 4 illustrate data management based on an update buffer in the cluster data management system of FIG. 1 according to the related art. FIG. 3 illustrates an operation of inserting data at a column address in a table named a column key. FIG. 4 illustrates the form of the update buffer after data insertion. The update buffer is arranged on the basis of row keys, column names, cell keys, and time stamps.

FIG. 5 illustrates the reflection of the update buffer on a disk according to the related art. Referring to FIG. 5, the contents of the update buffer are stored on the disk as they are.

Unlike the existing data management systems, the cluster data management system 10 takes no additional consideration for disk failure. Treatment for disk errors uses a file replication function of the distributed file system 20. To treat with a node failure, a redo-only log associated with a change is recorded for each partition server (i.e., node) at a location accessible by all computing nodes. Log information includes Log Sequence Numbers (LSNs), tables, row keys, column names, cell keys, time stamps, and change values. When a failure occurs in a computing node, the cluster data management system 10 recovers erroneous data to the original state by using a redo log that is recorded for error recovery in a failed node. A low-cost computing node, such as a commodity PC server, has almost no treatment for a failure such as hardware replication. Therefore, for achievement of high availability, it is important to treat with a node failure effectively on a software level.

FIG. 6 is a flow chart illustrating a failure recovery method in the cluster data management system according to the related art.

Referring to FIG. 6, the master server 11 detects whether a failure has occurred in the partition server (e.g., 12-1) (S610). If detecting the failure, the master server 11 arranges information of a log, which is written by the failed partition server 12-1, on the basis of tables, row keys, and log sequence numbers (S620). Thereafter, it divides log files by partitions in order to reduce a disk seek operation for data recovery (S630).

The master server 11 allocates partitions served by the failed partition server 12-1 to a new partition server (e.g., 12-2) (S640). At this point, redo log path information on the corresponding partitions is also transmitted.

The new partition server 12-2 sequentially reads a redo log, reflects an update history on an update buffer, and performs a write operation on a disk, thereby recovering the original data (S650).

Upon completion of the data recovery, the partition server 12-2 resumes a data service operation (S660).

However, this method of recovering the partitions, served by the failed partition server, in a parallel manner by distributing the partition recovery among a plurality of the partition servers 12-2, may fail to well utilize data storage features that record only the updated contents when storing data.

### SUMMARY

In one general aspect, a method for data restoration using a shared redo log in a cluster data management system, includes: collecting service information of a partition served by a failed partition server; dividing redo log files written by the partition server by columns of a table including the partition; restoring data of the partition on the basis of the collected service information and log records of the divided redo log files; and selecting a new partition server that will serve the data-restored partition, and allocating the partition to the selected partition server.

In another general aspect, a cluster data management system restoring data using a shared redo log includes: a partition server managing a service for at least one or more partitions and writing redo log files according to the service for the partition; and a master server collecting service information of the partitions in the event of a failure in the partition server, dividing the redo log files by columns of a table including the partition, and selecting the partition server that will restore data of the partition on the basis of the collected service information of the partition and the log information of the redo log files.

Other features and aspects will be apparent from the following detailed description, the drawings, and the claims.

### BRIEF DESCRIPTION OF THE DRAWINGS

FIG. 1 is a block diagram of a cluster data management system according to the related art.

FIG. 2 is a diagram illustrating a data model of a multidimensional map structure used in the cluster data management system of FIG. 1.

FIGS. 3 and 4 are diagrams illustrating data management based on an update buffer in the cluster data management system of FIG. 1.

FIG. 5 is a diagram illustrating reflection of the update buffer on a disk according to the related art.

FIG. 6 is a flow chart illustrating a failure recovery method in the cluster data management system according to the related art.

FIG. 7 is a block diagram of a cluster data management system according to an exemplary embodiment.

FIG. 8 is a diagram illustrating data recovery in FIG. 7.

FIG. 9 is a flow chart illustrating a data restoration method using the cluster data management system according to an exemplary embodiment.

FIG. 10 is a flow chart illustrating a method for restoring data of partitions on the basis of service information and log information of redo log files divided by columns according to an exemplary embodiment.

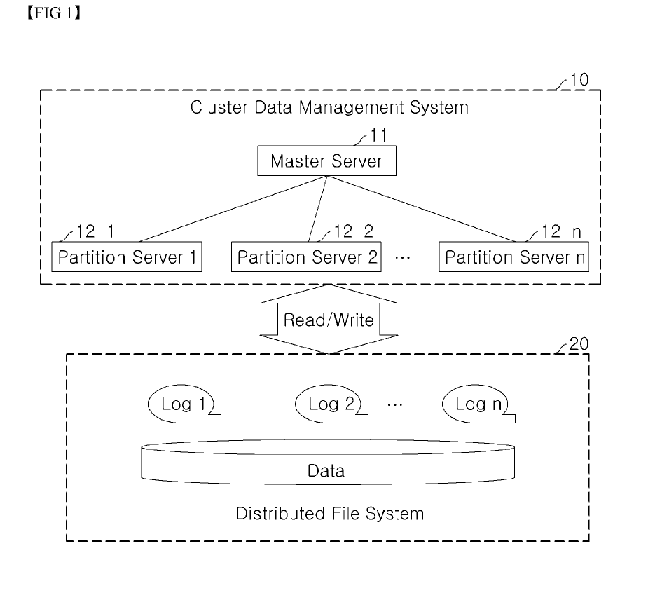

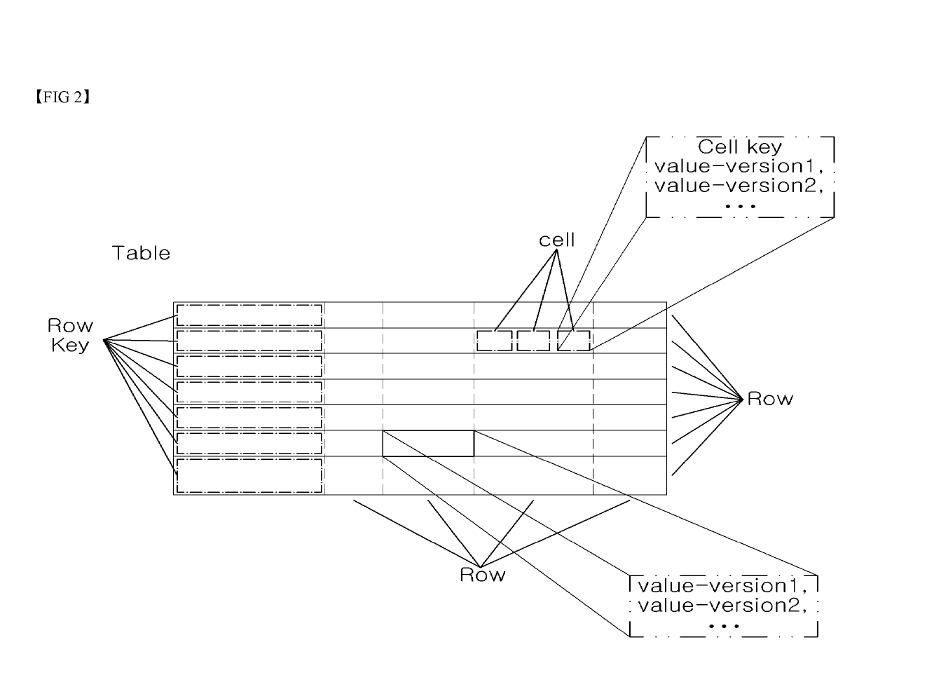

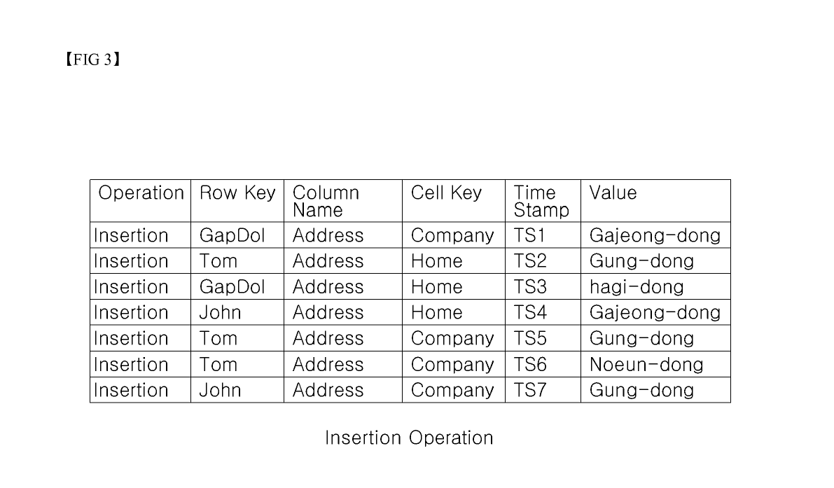

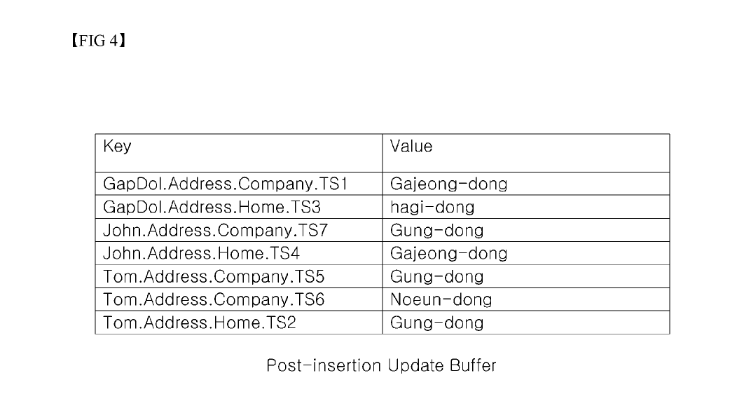

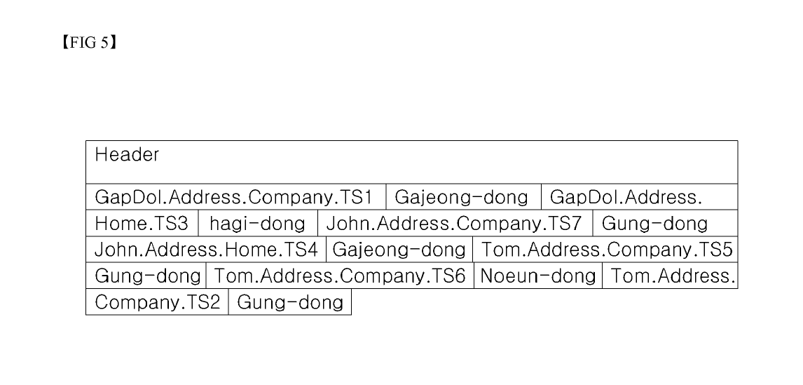

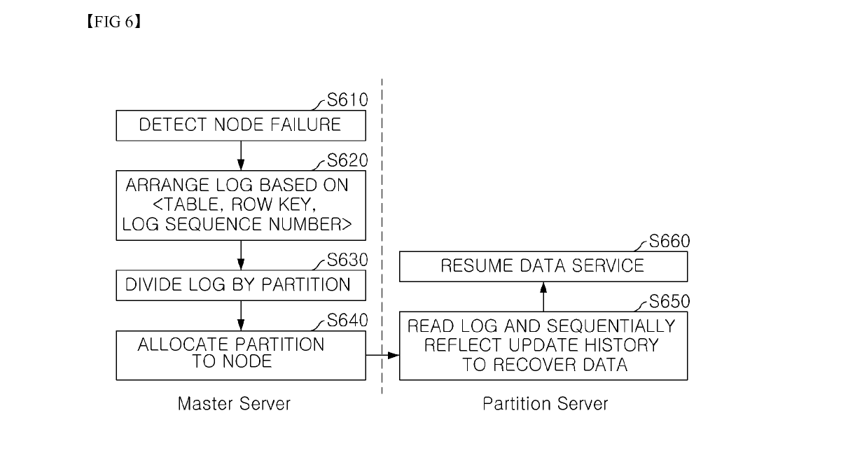

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

A data restoring method according to exemplary embodiments uses the feature that performs an operation in such a way as to add data with new values, instead of changing the previous data, when an insertion/deletion request causes a change in data.

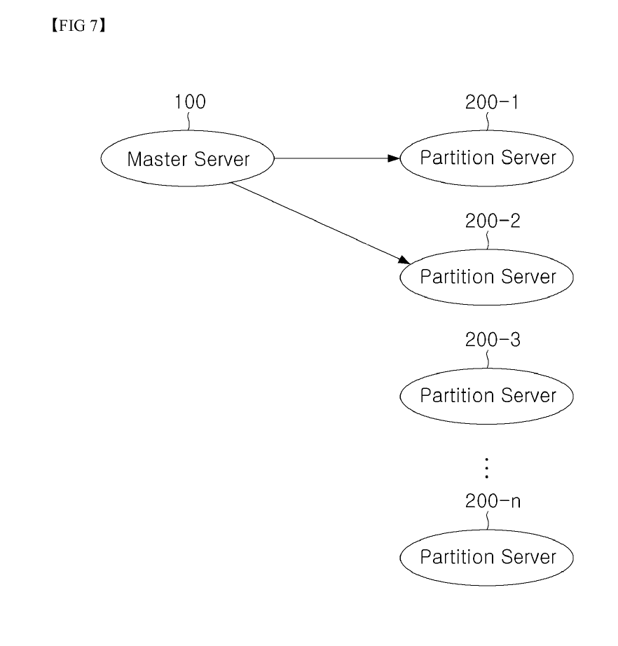

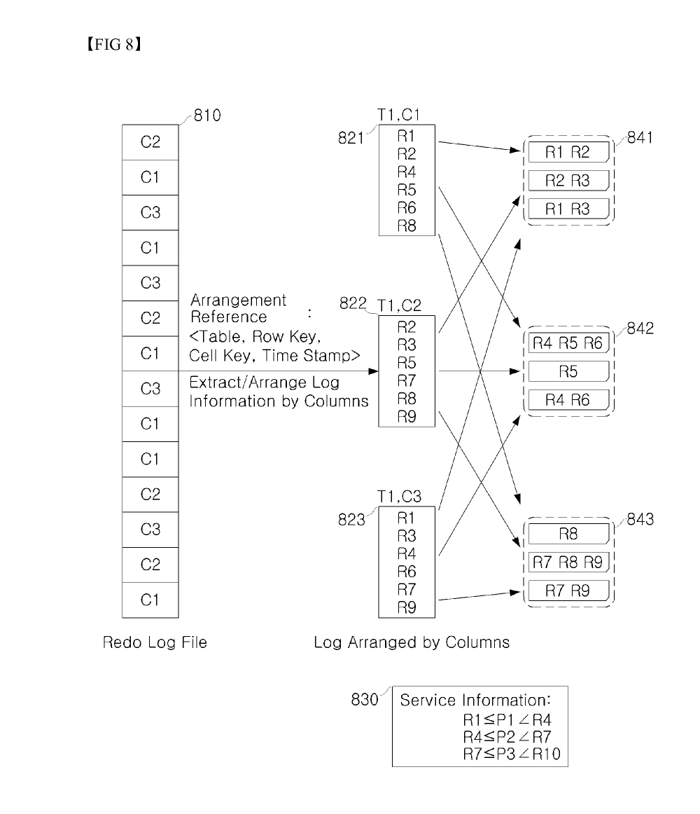

FIG. 7 is a block diagram of a cluster data management system according to an exemplary embodiment, and FIG. 8 is a diagram illustrating data recovery in FIG. 7.

Referring to FIG. 7, a cluster data management system according to an exemplary embodiment includes a master server 100 and partition servers 200-1, 200-2, . . . , 200-n.

The master server 100 controls each of the partition servers 200-1, 200-2, . . . , 200-n and detects whether a failure occurs in each of the partition servers 200-1, 200-2, . . . , 200-n.

If a failure occurs in a partition server (e.g., 200-3), the master server 100 collects service information of partitions served by a failed partition server (e.g., 200-3), and divides redo log files, which are written by the failed partition server 200-3, by columns of a table (e.g., T1) including the partition (e.g., P1, P2, P3) served by the partition server 200-3.

Herein, the service information of the partition includes information of the partition (P1, P2, P3) served by the failed partition server 200-3 (e.g., information indicating which of the partitions included in the table T1 is served by the failed partition server 200-3); information of columns constituting each of the partitions P1, P2 and P3 (e.g., C1, C2, C3); and row range information of the table T1 including each of the partitions P1, P2 and P3 (e.g., R1≦P1<R4, R4≦P2<R7, R7≦P3<R10).

The master server 100 arranges log information of the redo log files in ascending order on the basis of preset reference information (e.g., a table T1 including the partition (P1, P2, P3) served by the failed partition server 200-3, a row key, a cell key, and a time stamp), and sorts the arranged log records of the redo log files by columns of the Table T1 including the partition (P1, P2, P3) served by the failed partition server 200-3.

The master server 100 divides the sorted redo log files by columns.

The master server 100 selects a new partition server (e.g., 200-1) that will restore the data of the partition (P1, P2, P3) served by the failed partition server 200-3, on the basis of the service information of the partition and the log information of the redo log files.

The master server 100 transmits the collected service information and the divided redo log files to the selected partition server 200-1.

Upon completion of the data recovery of the partition (P1, P2, P3) by the selected partition server 200-1, the master server 100 selects a new partition server (e.g., 200-2) that will serve the data-restored partition.

The master server 100 allocates the data-restored partition to the new partition server 200-2.

Upon receiving the service information and the redo log files from the master server 100, each partition server (200-1, 200-2, . . . , 200-n) restores data of the partition on the basis of the received service information and the log information of the divided redo log files.

Each partition server (200-1, 200-2, . . . , 200-n) generates a data file for restoring the data of the partition on the basis of the received service information and the log information of the divided redo log files, and records the log information of the redo log files in the generated data file.

Herein, the log information may be log records.

When recording the log information of the redo log files in the generated data file of the partition, each partition server (200-1, 200-2, . . . , 200-n) determines whether the log information of the redo log files belongs to the partition under data restoration.

If the log information of the redo log files belongs to the partition under data restoration, each partition server (200-1, 200-2, . . . , 200-n) generates and records information in the generated data file on the basis of the log information of the redo log files.

If the log information of the redo log files does not belong to the partition under data restoration, each partition server (200-1, 200-2, . . . , 200-n) generates a new data file, and generates and records information in the generated data file on the basis of the log information of the redo log files. When generating the information to be written data file on the basis of the log records, a log sequence number is excluded.

Herein, the information to be recorded in the data file may be the records of the data file.

When being allocated the data-restored partition, each partition server (200-1, 200-2, . . . , 200-n) starts a service for the allocated partition.

FIG. 8 illustrates the data recovery of FIG. 7 according to an exemplary embodiment. Referring to FIG. 8, a failure occurs in the partition server 200-3; the partition server 200-1 is selected by the maser server 100 to restore the data of the partition (P1, P2, P3) served by the partition server 200-3; the table T1 includes columns C1, C2 and C3; and the partition (P1, P2, P3) served by the partition server 200-3 belongs to the table T1.

The master server 100 arranges log information of redo log files 810 in ascending order on the basis of preset reference information (e.g., a table T1 including the partition (P1, P2, P3) served by the failed partition server 200-3, a row key, a cell key, and a time stamp), and sorts it by columns of the table T1.

The master server 100 divides redo log files by columns, which is obtained by sorting the log information by the columns of the table T1.

Herein, the redo log files may be divided by columns, like a (T1.C1) 821, a (T1.C2) 822, and a (T1.C3) 823.

The (T1.C1) 821 includes log information on a column C1 of the table T1. The (T1.C2) 822 includes log information on a column C2 of the table T1. The (T1.C3) 823 includes log information on a column C3 of the table T1.

On the basis of service information 830 of partitions P1, P2 and P3, the partition server 200-1 determines which of the partitions P1, P2 and P3 the log information of the redo log files, divided by columns, belongs to. The partition server 200-1 generates a data file of the partition according to the determination results. The partition server 200-1 generates and records information in the generated data file on the basis of the log information of the redo log files, like reference numerals 841, 842 and 843. Reference numerals 841, 842 and 843 denote data files of the partitions P1, P2 and P3, respectively.

Although not described herein, the core concept of the exemplary embodiments may also be easily applicable to systems using the concept of a row group. Also, when a failure occurs in the partition server, the exemplary embodiments restore data of the failed partition server. The exemplary embodiments restore the data directly from the redo log files without using an update buffer, thereby reducing unnecessary disk input/output.

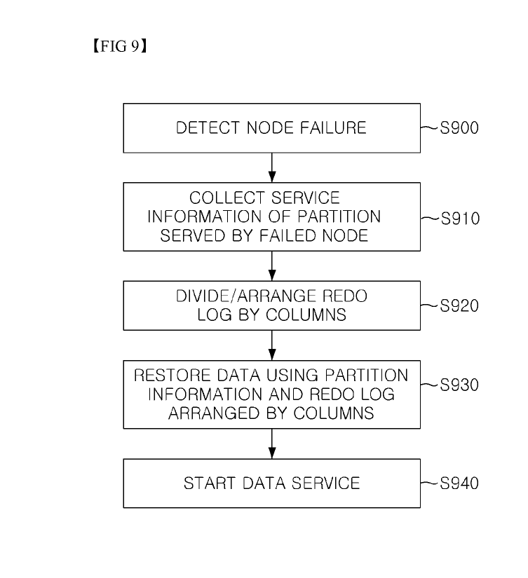

FIG. 9 is a flow chart illustrating a data restoration method using the cluster data management system according to an exemplary embodiment.

Referring to FIG. 9, the master server 100 detects whether a failure occurs in each of the partition servers 200-1, 200-2, . . . , 200-n (S900).

If a failure occurs in one of the partition servers 200-1, 200-2, . . . , 200-n, the master server 100 collects service information of partitions (e.g., P1, P2, P3) served by a failed partition server (e.g., 200-3) (S910).

Herein, the service information of the partition includes information of the partition (P1, P2, P3) served by the failed partition server 200-3 (e.g., information indicating which of the partitions included in the table T1 is served by the failed partition server 200-3); information of columns constituting each of the partitions P1, P2 and P3 (e.g., C1, C2, C3); and row range information of the table T1 including each of the partitions P1, P2 and P3 (e.g., R1≦P1<R4, R4≦P2<R7, R7≦P3<R10).

The master server 100 divides redo log files, which are written by the failed partition server 200-3, by columns (S920).

The master server 100 arranges log information of the redo log files in ascending order on the basis of preset reference information (e.g., a table T1 including the partition (P1, P2, P3) served by the failed partition server 200-3, a row key, a cell key, and a time stamp). The master server 100 sorts the arranged information of the redo log files by columns of the Table T1 including the partition (P1, P2, P3) served by the failed partition server 200-3, and divides the sorted redo log files by columns.

The master server 100 selects a partition server (e.g., 200-1) that will restore the data of the partition (P1, P2, P3) served by the failed partition server 200-3.

For example, the master server 100 may select the partition server 200-1 to restore the data of the partition (P1, P2, P3).

The master server 100 transmits the collected service information and the divided redo log files to the selected partition server 200-1.

The partition server 200-1 restores the data of the partition (P1, P2, P3) on the basis of the log information of the divided redo log files and the service information received form the master server 100 (S930).

Upon completion of the data recovery of the partition (P1, P2, P3) by the partition server 200-1, the master server 100 selects a new partition server (e.g., 200-2) that will serve the partition (P1, P2, P3), and allocates the partition (P1, P2, P3).

Upon being allocated the data-restored partition (P1, P2, P3), the partition server 200-2 starts a service for the allocated partition (P1, P2, P3) (S940).

Dividing/arranging the redo log by columns and restoring the data may use software for parallel processing such as Map/Reduce.

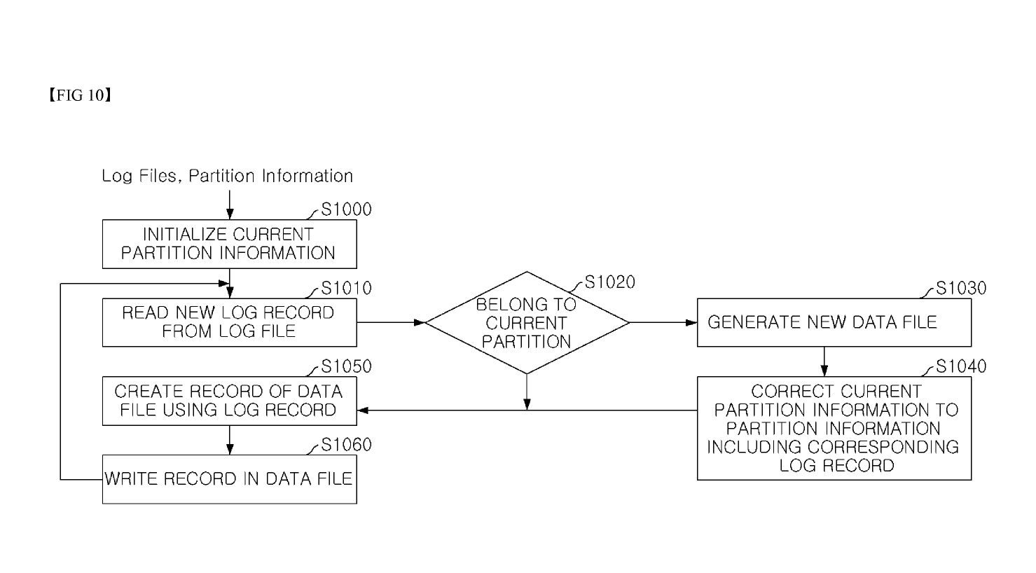

FIG. 10 is a flow chart illustrating a method for restoring data of partitions on the basis of service information and log information of redo log files divided by columns according to an exemplary embodiment.

Referring to FIG. 10, the partition server 200-1 receives service information and divided redo log files from the master server 100.

The partition server 200-1 initializes information of the partition (e.g., an identifier (i.e., P) of the partition whose data is to be restored) before restoring the data of the partition (P1, P2, P3) on the basis of the received service information and information of the divided redo log files (S1000).

On the basis of the service information and the log information of the redo log files (S1010), the partition server 200-1 determines whether the log information of the redo log files belongs to the current partition whose data are being restored (S1020).

If the log information of the redo log files does not belong to the current partition, the partition server 200-1 generates a data file of the partition (S1030), and corrects the information of the current partition to the log information of the redo log files, i.e., the partition information including the log records (S1040).

For example, if the current partition information P is the partition P1, the partition server 200-1 determines whether R4 of the (T1.C1) 821 belongs to the current partition P1 on the basis of the service information including R4 of the (T1.C1) 821 (e.g., R1≦P1<R4, R4≦P2<R7, R7≦P3<R10). If R4 does not belong to the current partition P1, the partition server 200-1 generates the data file 842 of the partition P2 including R4, and corrects the current partition information P to the log information of the redo log files, i.e., the partition P2 including R4.

On the other hand, the log information of the redo log files belongs to the current partition, the partition server 200-1 uses the log information (i.e., log records) of the redo log files to create information to be recorded in the generated data file, i.e., the records of the data file (S1050).

The partition server 200-1 directly records the created information (i.e., the records of the data file) in the data file (S1060).

For example, if R2 of the (T1.C2) belongs to the current partition P1, the partition server 200-1 records R2 in the data file 841 of the partition P1 directly without using the update buffer.

Operations 1010 to 1060 are repeated until the redo logs for all the columns divided are used for data restoration of the partition (P1, P2, P3).

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for data restoration using a shared redo log in a cluster data management system, the method comprising:
collecting service information of a partition served by a failed partition server;
dividing redo log files written by the partition server by columns of a table including the partition;
restoring data of the partition on the basis of the collected service information and log records of the divided redo log files; and
selecting a new partition server that will serve the data-restored partition, and allocating the partition to the selected partition server.

2. The method of claim 1, wherein the service information includes information of the partition served by the failed partition server, information of the columns constituting each partition; and row range information of a table including each partition.

3. The method of claim 1, wherein the dividing of redo log files comprises:
arranging log information of the redo log files on the basis of preset reference information;
sorting the arranged log information of the redo log files by the columns; and
dividing the redo log files with the sorted log information by the columns.

4. The method of claim 3, wherein the reference information includes a table including the partition served by the failed partition server, a row key, a cell key, and a time stamp.

5. The method of claim 1, wherein the restoring of data of the partition comprises:
selecting a partition server that will restore the data of the partition;
transmitting the collected service information and the divided redo log files to the selected partition server;
generating a new data file on the basis of the received service information and the log information of the redo log files; and
recording log records of the redo log files in the generated data file.

6. The method of claim 5, wherein the recording of log records of the redo log files comprises:
determining whether the record information of the redo log files belongs to the current partition whose data is being restored; and
recording the log records of the redo log files in the generated data file if the record information of the redo log files belongs to the current partition.

7. The method of claim 6, wherein the recording of the log records of the redo log files comprises:
generating a new data file if the record information of the redo log files does not belong to the current partition; and
recording the log records of the redo log files in the generated data file.

8. The method of claim 5, wherein the recording of the log information comprises:
generating information to be recorded in a data file, on the basis of other information than log sequence numbers of the log information of the redo log files; and
recording the generated information in the generated data file.

9. The method of claim 1, further comprising:
starting a service for the data-restored partition by the partition server allocated the partition.

10. A cluster data management system that restores data using a shared redo log, the cluster data management system comprising:
a partition server managing a service for at least one or more partitions and writing redo log files according to the service for the partition; and
a master server collecting service information of the partitions in the event of a partition server failure, dividing the redo log files by columns of a table including the partition, and selecting the partition server that will restore data of the partition on the basis of the collected service information of the partition and the log information of the redo log files.

11. The cluster data management system of claim 10, wherein the service information includes information of the partition served by the failed partition server, information of the columns constituting each partition; and row range information of a table including each partition.

12. The cluster data management system of claim 10, wherein the master server arranges log information of the redo log files on the basis of preset reference information, sorts the arranged log information of the redo log files by the columns, and divides the redo log files by the columns.

13. The cluster data management system of claim 12, wherein the reference information includes a table including the partition served by the failed partition server, a row key, a cell key, and a time stamp.

14. The cluster data management system of claim 10, wherein the master server transmits the collected service information and the divided redo log files to the selected partition server.

15. The cluster data management system of claim 14, wherein the partition server restores data of the partition on the basis of the received service information and the log information of the divided redo log files.

16. The cluster data management system of claim 15, wherein the partition server generates a data file for data restoration of the partition on the basis of the received service information and the log information of the redo log files, and records the log information of the redo log files in the generated data file of the partition.

17. The cluster data management system of claim 16, wherein the partition server determines whether the log information of the redo log files belongs to the current partition whose data is being restored, and records the log information in the generated data file if the log information belongs to the current partition.

18. The cluster data management system of claim 17, wherein the partition server generates a new data file if the log information of the redo log files does not belong to the current partition, and records the log information in the generated data file.

19. The cluster data management system of claim 16, wherein the partition server generates information to be recorded in the data file, on the basis of other information than log sequence numbers of the log information of the redo log files, and records the generated information in the generated data file.

20. The cluster data management system of claim 15, wherein the master server selects a new partition server that will serve the data-restored partition, and allocates the partition to the selected partition server.
